(19) United States
(12) Patent Application Publication
(10) Pub. No.: US 2026/0319496 A1
(43) Pub. Date: Oct. 15, 2026

(54) INTEGRATED SYSTEM AND METHOD FOR AUTONOMOUS VEHICLE NAVIGATION AND 3D ENVIRONMENT MAPPING USING MULTI-MODAL SENSING

(71) Applicant: Oceaneering International, Inc., Houston, TX (US)

(72) Inventor: Sudheendra Krishnamurthy, Bengaluru - 78 (IN)

(73) Assignee: Oceaneering International, Inc., Houston, TX (US)

(21) Appl. No.: 19/648,372

(22) Filed: Apr. 15, 2026

(30) Foreign Application Priority Data
Apr. 15, 2025 (IN) 202511036258

(51) Int. Cl. G05D 1/246; G05D 1/644; G05D 1/85; G05D 111/10; G05D 111/20; G05D 111/50; G05D 111/67

(52) U.S. Cl. CPC G05D 1/246; G05D 1/644; G05D 1/857; G05D 2111/17; G05D 2111/20; G05D 2111/52; G05D 2111/67

(57) ABSTRACT

The disclosed invention provides robust multi-sensor fusion, real-time autonomous navigation, adaptive environmental response, simplified deployment process, and reduced operational costs. Its components form an interconnected pipeline for autonomous navigation and environmental perception. Sensors provide environmental data; processing components such as but not limited to the sensor data processor interpret sensor data; vision components such as those in the core processor handle visual perception; data management via the data manager ensures proper data flow; communication between the various processors enables component interaction; and output components such as those in the output layer processor deliver usable results.

### CROSS-REFERENCE TO RELATED APPLICATIONS

This application claims priority through India Provisional Application 202511036258 filed on Apr. 15, 2025, incorporated herein by reference.

### BACKGROUND OF THE INVENTION

Current autonomous navigation systems for remotely operated vehicles (ROVs), drones, and industrial vehicles face several critical challenges, including reliability issues such as poor performance in low-visibility conditions, navigation failures in GPS-denied environments, and/or inaccurate depth perception, leading to collisions; operational limitations such as manual docking/landing requirements, slow inspection speeds due to safety concerns, and/or limited autonomous capabilities; integration challenges such as complex setup requirements, poor interoperability between sensors, and/or high latency in real-time processing; and/or cost impact arising from extended operation times, higher personnel requirements, equipment damage from collisions, and/or increased downtime.

The current market solutions for autonomous vehicle navigation and 3D environment mapping has several limitations, including requiring manual piloting with basic automation or only possessing basic obstacle avoidance such as in commercial ROV Systems; being dependent on GPS navigation, requiring visual navigation that is typically limited to well-lit conditions, and/or having limited range perception such as in drone navigation systems; requiring fixed path navigation, use of 2-D based navigation, and/or having limited obstacle handling, such as with industrial automated guided vehicle (AGV) solutions.

In most of these solutions, key limitations include single-sensor dependency, poor performance in challenging environments, limited real-time processing, high latency, manual intervention requirements, and/or requiring separate systems for different platforms.

### BRIEF DESCRIPTION OF DRAWINGS

Various figures are included herein which illustrate aspects of embodiments of the disclosed inventions.

FIG. 1 is a block diagram of an exemplary modular, scalable integrated system for autonomous vehicle navigation and three-dimensional (3D) environment mapping using multi-modal sensing.

### DETAILED DESCRIPTION OF EMBODIMENTS OF THE INVENTION

The disclosed invention comprises an integrated hardware-software system. As used herein, a “processor” or “computing unit” comprises hardware, comprising a central processing unit and associated random access memory and/or a specialized hardware, software executable in the hardware, or the like, or a combination thereof, e.g., an NVIDIA Jetson Orin processor.

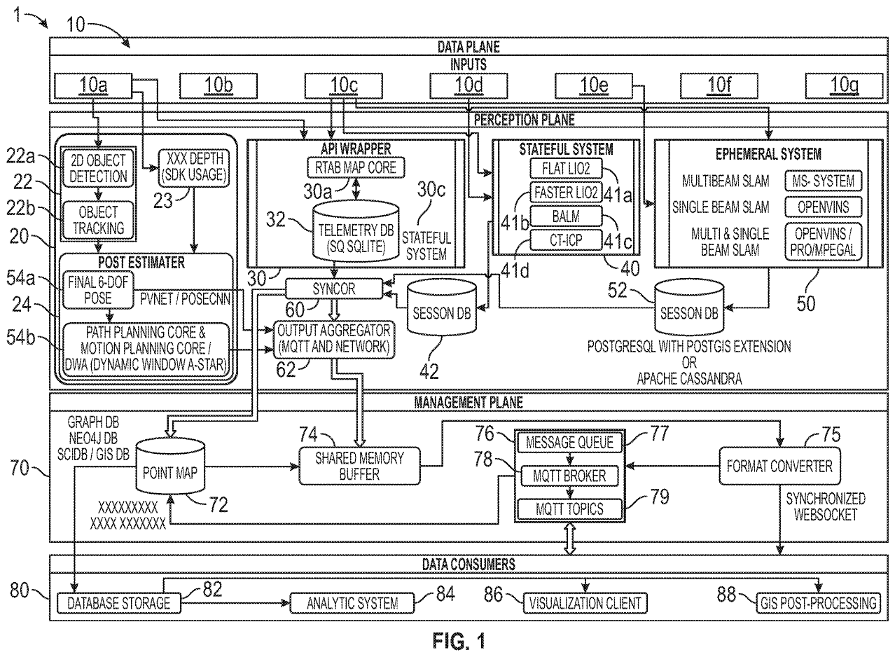

In a first embodiment, referring generally to FIG. 1, modular, scalable integrated system for autonomous vehicle navigation and three-dimensional (3D) environment mapping using multi-modal sensing 1 comprises a plurality of sensors 10, each sensor comprising a modal sensor data output; perception processor 20, comprising object processor 22 which, in turn, comprises two-dimensional (2D) object detector 22a operatively in communication with stereo sensor 10a of the plurality of sensors 10; object tracker 22b operatively in communication with 2D object detector 22a; stereo depth processor 23 operatively in communication with stereo sensor 10a of the plurality of sensors 10 which may further comprise a 3D vision stereo camera; and pose estimator 24 operatively in communication with object tracker 22b and stereo depth processor 23; application programming interface (API) wrapper 30 operatively in communication with stereo sensor 10a of the plurality of sensors 10 and with inertial measurement unit (IMU) sensor 10c of the plurality of sensors 10, the API wrapper comprising real-time appearance-based mapping (RTAB) map core 30a, first sessions database 32 operatively in communication with RTAB map core 30a, and API database manager 30c operatively in communication with RTAB map core 30a and first sessions database 32; simultaneous localization and mapping (SLAM) integrator 40 comprising a predetermined plurality of SLAM implementations 41a,41b,41c, 41d and operatively in communication with IMU sensor 10c and with LiDAR sensor 10d of the plurality of sensors 10; second sessions database 42 operatively in communication with SLAM integrator 40; ephemeral processor 50 operatively in communication with IMU sensor 10c and SONAR sensor 10e of the plurality of sensors 10; third sessions database 52 operatively in communication with ephemeral processor 50; real time synchronizer 60 operatively in communication with first sessions database 360b, second sessions database 42, and third sessions database 52; output aggregator 62 operatively in communication with pose estimator 24 and synchronizer 60; data manager 70, comprising world map database 72 operatively in communication with synchronizer 60, shared memory/buffer 74 operatively in communication with output aggregator 62 and world map database 72, format converter 75 operatively in communication with shared memory/buffer 74, message queue manager 76 operatively in communication with format converter 75; and data consumer 80 comprising database store 82 which is operatively in communication with world map database 72, navigator 84 operatively in communication with database store 82; visualization client 86 operatively in communication with database store 82, and graphics display interface (GDI) post processor 88 operatively in communication with database store 82.

In embodiments, the plurality of sensors 10 provides sensed data to perception processor 20 via a plurality of parallel pipelines. These predetermined set of parallel pipelines may comprise a plurality of real-time processing pipelines, comprising a visual processing pipeline utilizing data from 2D object detector 22a, object track processor 22b, stereo depth processor 23, and pose estimator 24; a core processor pipeline utilizing data from API wrapper 30 and stateful processor ______; and a SLAM pipeline utilizing data from ephemeral processor 40 and stateful processor ______.

The plurality of sensors 10 may further comprise monocular sensor 10b; RGB-D sensor 10f, and environmental sensor 10g.

In embodiments pose estimator 54 comprises final six degree of freedom (6-DOF) pose 54a and path planning processor 54b operatively in communication with final 6-DOF pose 54a. Typically, path planning processor 54b comprises a dynamic window.

In embodiments, multiple SLAM implementations comprise: LiDAR-inertial odometry package (FAST-LIO2) SLAM 41a for a LIDAR-based SLAM; universal Front-End workflow SLAM (BALM) 41b for additional mapping capabilities; continuous time iterative closest point (CT-ICP) SLAM 41c for point cloud processing; MultiBeam SLAM 41d; Single Beam SLAM 41e; and integrator 43 comprising an OpenNav and Ephemeral System.

In embodiments, ephemeral processor 50 comprises MultiBeam SLAM processor 51a, first OpenNav system 51b adapted to process a Single Beam SLAM, and second OpenNav system 51c adapted process both a MultiBeam SLAM and a Single Beam SLAM.

Typically, 2D object detector 22a is configured to identify an object in a camera data set; object tracker 22b is configured to follow an identified object from 2D object detector 22a across a predetermined set of video frames; stereo sensor 10a comprises a stereo camera; stereo depth detector 23 is configured to process data from the stereo camera and obtain depth information; and pose estimator 54 is configured to combine data from 2D object detector 11a, object track processor 22b, and stereo depth detector 23 and process the combined data to determine a position and orientation of the identified object.

In embodiments, message queue manager 76 comprises message queue broker 77, message queuing telemetry transport (MQTT) broker 78 operatively in communication with message queue broker 76 and world map database 72, and MQTT topics processor 79 operatively in communication with MQTT broker 78.

In embodiments, format converter 75 is configured to provide synchronized websocket data useful for real-time communication.

In the operation of exemplary methods, referring still to FIG. 1, autonomous vehicle navigation and three-dimensional (3D) environment mapping using multi-modal sensing may be provided using modular, scalable integrated system 1 as described herein above to plan a path for an autonomous vehicle by obtaining data from the plurality of sensors 10 in real-time; using world map data from world map database 72 set to maintain an environmental model; using perception processor 20 to use stereo depth detector 23 to process data, including obtaining depth information, from stereo camera 10a of the plurality of sensors 10; using monocular camera 10b of the plurality of sensors 10 for basic visual input; using IMU sensor 10c of the plurality of sensors 10 for motion tracking; using LIDAR sensor 10d of the plurality of sensors 10 for precise distance measurement; using SONAR sensor 10e of the plurality of sensors 10 for obstacle detection; and using an RGB-D camera 10f of the plurality of sensors 10 for combined color and depth data; using SLAM integrator 40 to improve localization accuracy by combining multiple SLAM approaches in parallel and provide real-time switching between SLAM methods based on environmental conditions; using perception processor 20 to integrate the data obtained from the plurality of sensors 10 in real-time and persist the data in sessions; generating a real-time dynamic path trajectory for the autonomous vehicle by using real-time 3D reconstruction by using 24 pose estimator to combine data from 2D object detector 22a, object track processor 22b, and stereo depth detector 23 and process the combined data using parallel processing pipelines to determine position and orientation of an identified object; cross-validating sensor readings; maintaining system state data across sessions; handling dynamic environment updates; and managing temporal data consistency.

In embodiments, a predetermined usage policy for stereo depth processing may be implemented to optimize computational resources and a dynamic weighting system used that automatically adjusts sensor input importance based on environmental conditions combined with a smart fallback system when certain sensors 10 of the plurality of sensors 10 fail or become unreliable.

Integrating data from the plurality of sensors 10 in real-time may comprise using parallel processing pipelines, efficient data synchronization, and low-latency communication through MQTT.

In embodiments, an intelligent state manager may be used to create and/or maintain session persistence to maintain environmental awareness across system restarts. In these embodiments, databases 32,42,52,72,82 may be used to enable rapid state recovery and provide continuity and reliability.

In embodiments, an enhanced path planning system comprising pose estimator 24 may be implemented by combining dynamic window A* with real-time pose estimation to integrate pose estimation with path planning in a single coherent pipeline. As those of skill in these arts understands, A* is an algorithm that can be used to find a shortest path and a dynamic A* (sometimes referred to as D*) is an incremental heuristic search algorithm that combines ideas of A* and Dynamic SWSF-FP.

In embodiments, an advanced data management architecture may be present using ephemeral processor 50 by combining a graphics database manager for topological relationships, a second database manager, e.g., PostgreSQL with PostGIS, for spatial data, and a third database manager, e.g., Apache Cassandra, for time-series data.

In embodiments where message queue manager 76 comprises message queue broker 77 and message queuing telemetry transport (MQTT) broker 78 operatively in communication with message queue broker 77 and world map database 72, real-time synchronizer 60 may be used to handle multi-sensor data alignment by integrating the MQTT with websocket data for real-time data streaming.

In embodiments, output aggregator 62 may combine multiple data streams using a MQTT and Websocket protocols for real-time data distribution.

As will be apparent to those of ordinary skill, modular, scalable integrated system 1 provides robust navigation comprising multi-modal sensor fusion, real-time SLAM implementation, dynamic obstacle avoidance, and autonomous docking capability; environmental adaptation comprising automatic exposure/gain control, sensor weighting based on conditions, and fault detection and recovery; enhanced performance metrics comprising a 30 Hz update rate, 2-5 cm localization accuracy, 10 Hz path planning, and <100 ms control latency; and safety systems comprising emergency stop protocols, health monitoring, collision prediction, and failsafe behaviors. In addition, the disclosed invention provides cross-platform compatibility (ROV/AUV/drone/forklift).

Compared to existing systems modular, scalable integrated system 1 provides superior environmental adaptation via multi-sensor fusion as opposed to single sensor dependency, real-time adaptation to visibility conditions, and cross-platform capability (remotely operated vehicle (ROV)/drone/forklift); enhanced performance via real-time 3D reconstruction vs post-processing; advanced autonomy via dynamic path planning vs fixed routes, autonomous docking vs manual intervention, active obstacle avoidance vs passive detection, and multi-modal SLAM vs single-source mapping; operational benefits including 60% reduction in manual intervention, 40% faster inspection speeds, 30% lower operational costs, and cross-environment functionality.

In most embodiments, modular, scalable integrated system 1 comprises a scalable and modular architecture comprising modular component design, multiple database options for different data types, and distributed processing capability. This architecture provides a comprehensive solution for autonomous navigation with robust perception capabilities, efficient data management, and real-time processing. Modular, scalable integrated system 1 can handle complex environments while maintaining reliability and performance through its multi-layered approach and redundant systems.

In its embodiments, modular, scalable integrated system 1 comprises superior reliability, multiple redundant systems, intelligent failover capabilities, cross-validation of sensor data, enhanced accuracy, a multi-SLAM approach which improves localization accuracy, advanced sensor fusion which reduces error rates, and real-time pose estimation which improves navigation precision. It can lead to better performance via optimized resource usage, efficient data management, and real-time processing capabilities.

The foregoing disclosure and description of the inventions are illustrative and explanatory. Various changes in the size, shape, and materials, as well as in the details of the illustrative construction and/or an illustrative method may be made without departing from the spirit of the invention.

1) A modular, scalable integrated system for autonomous vehicle navigation and three-dimensional (3D) environment mapping using multi-modal sensing, comprising:
a) a plurality of sensors, each sensor comprising a modal sensor data output;
b) a perception processor, comprising:
i) an object processor, comprising
(1) a two-dimensional (2D) object detector operatively in communication with a stereo sensor of the plurality of sensors;
(2) an object tracker operatively in communication with the 2D object detector;
(3) a stereo depth processor operatively in communication with the stereo sensor of the plurality of sensors; and
(4) a pose estimator operatively in communication with the object tracker and the stereo depth processor;
ii) an application programming interface (API) wrapper operatively in communication with the stereo sensor of the plurality of sensors and with an inertial measurement unit (IMU) sensor of the plurality of sensors, the API wrapper comprising:
(1) a real-time appearance-based mapping (RTAB) map core;
(2) a first sessions database operatively in communication with the RTAB map core; and
(3) an API database manager operatively in communication with the RTAB map core
and the first sessions database;
iii) a simultaneous localization and mapping (SLAM) integrator comprising a predetermined plurality of SLAM implementations and operatively in communication with the IMU sensor and with a LiDAR sensor of the plurality of sensors;
iv) a second sessions database operatively in communication with the SLAM integrator;
v) an ephemeral processor operatively in communication with the IMU sensor and a SONAR sensor of the plurality of sensors;
vi) a third sessions database operatively in communication with the ephemeral processor;
vii)a real time synchronizer, operatively in communication with the first sessions database, the second sessions database, and the third sessions database;
viii) an output aggregator operatively in communication with the pose estimator and the synchronizer;
c) a data manager, comprising:
i) a world map database operatively in communication with the synchronizer;
ii) a shared memory/buffer operatively in communication with the output aggregator and the world map database;
iii) a format converter operatively in communication with the shared memory/buffer;
iv) a message queue manager operatively in communication with the format converter; and
d) a data consumer, comprising:
i) a database store, operatively in communication with the world map database;
ii) a navigator operatively in communication with the database store;
iii) a visualization client operatively in communication with the database store; and
iv) a graphics display interface (GDI) post processor operatively in communication with the database store.

2) The system of claim 1, wherein the plurality of sensors provides sensed data to the perception processor via a plurality of parallel pipelines.

3) The system of claim 2, wherein the predetermined set of parallel pipelines comprises a plurality of real-time processing pipelines, comprising:
a) a visual processing pipeline utilizing data from the 2D object detector, the object track processor, the stereo depth processor, and the pose estimator;
b) a core processor pipeline utilizing data from the API wrapper and the stateful processor; and
c) a SLAM pipeline utilizing data from the ephemeral processor and the stateful processor.

4) The system of claim 1, wherein the plurality of sensors further comprises:
a) a monocular sensor;
b) an RGB-D sensor; and
c) an environmental sensor.

5) The system of claim 1, wherein the stereo sensor comprises a 3D vision stereo camera.

6) The system of claim 1, wherein the pose estimator comprises:
a) a final six degree of freedom (6-DOF) pose; and
b) a path planning processor operatively in communication with the final 6-DOF pose, the path planning processor further comprising a dynamic window

7) The system of claim 1, wherein:
a) the multiple SLAM implementations comprise:
i) a LiDAR-inertial odometry package (FAST-LIO2) SLAM for a LIDAR-based SLAM;
ii) a universal Front-End workflow SLAM (BALM) for additional mapping capabilities;
iii) a continuous time iterative closest point (CT-ICP) SLAM for point cloud processing;
iv) a MultiBeam SLAM;
v) a Single Beam SLAM; and
b) an integrator comprising an OpenNav and Ephemeral System.

8) The system of claim 1, wherein the ephemeral processor comprises:
a) a MultiBeam SLAM processor;
b) a first OpenNav system adapted to process a Single Beam SLAM; and
c) a second OpenNav system adapted process both a MultiBeam SLAM and a Single Beam SLAM.

9) The system of claim 1, wherein:
a) the 2D object detector is configured to identify an object in a camera data set;
b) the object tracker is configured to follow an identified object from the 2D object detector across a predetermined set of video frames;
c) the stereo sensor comprises a stereo camera;
d) the stereo depth detector is configured to process data from the stereo camera and obtain depth information; and
e) the pose estimator is configured to combine data from the 2D object detector, the object track processor, and the stereo depth detector and process the combined data to determine position and orientation of the identified object.

10) The system of claim 1, wherein the message queue manager comprises:
a) a message queue broker;
b) a message queuing telemetry transport (MQTT) broker operatively in communication with the message queue broker and the world map database; and
c) an MQTT topics processor operatively in communication with the MQTT broker.

11) The system of claim 1, wherein the format converter is configured to provide synchronized websocket data useful for real-time communication.

12) A method of providing autonomous vehicle navigation and three-dimensional (3D) environment mapping using multi-modal sensing using the system of claim 1 to plan a path for an autonomous vehicle, comprising:
a) obtaining data from the plurality of sensors in real-time;
b) using the world map data set to maintain an environmental model;
c) using the perception processor, further comprising:
i) using the stereo depth detector to process data, including obtain depth information, from a stereo camera of the plurality of sensors;
ii) using a monocular camera of the plurality of sensors for basic visual input;
iii) using an inertial measurement unit (IMU) of the plurality of sensors for motion tracking;
iv) using a LIDAR sensor of the plurality of sensors for precise distance measurement;
v) using a SONAR sensor of the plurality of sensors for obstacle detection; and
vi) using an RGB-D camera of the plurality of sensors for combined color and depth data;
d) using the SLAM integrator to improve localization accuracy by combining multiple SLAM approaches in parallel and provide real-time switching between SLAM methods based on environmental conditions;
e) using the perception processor integrate the data obtained from the plurality of sensors in real-time and persist the data in sessions; and
f) generating a real-time dynamic path trajectory for the autonomous vehicle by using real-time 3D reconstruction, comprising:
i) using the pose estimator to combine data from the 2D object detector, the object track processor, and the stereo depth detector; and
ii) processing the combined data using parallel processing pipelines to determine position and orientation of an identified object.

13) The method of claim 12, further comprising:
a) implementing a predetermined usage policy for stereo depth processing to optimize computational resources; and
b) using a dynamic weighting system that automatically adjusts sensor input importance based on environmental conditions combined with a smart fallback system when certain sensors fail or become unreliable.

14) The method of claim 12, wherein comprising integrating data from the plurality of sensors in real-time comprises using parallel processing pipelines, efficient data synchronization, and low-latency communication through MQTT.

15) The method of claim 12, further comprising:
a) enabling an intelligent state management comprising session persistence to maintain environmental awareness across system restarts; and
b) using the databases to enable rapid state recovery and provide continuity and reliability.

16) The method of claim 12, further comprising implementing an enhanced path planning system comprising the pose estimator by combining dynamic window A-star with real-time pose estimation to integrate pose estimation with path planning in a single coherent pipeline.

17) The method of claim 12, further comprising implementing an advanced data management architecture comprising the ephemeral processor by combining a graphics database manager for topological relationships, a second database manager for spatial data, and a third database manager for time-series data.

18) The method of claim 12, wherein:
a) the message queue broker comprises a message queue broker and a message queuing
telemetry transport (MQTT) broker operatively in communication with the message queue broker and the world map database; and
b) the real-time synchronizer handles multi-sensor data alignment by integrating the MQTT with websocket data for real-time data streaming.

19) The method of claim 12, further comprising using the output aggregator to combine multiple data streams using a MQTT and Websocket protocols for real-time data distribution.
